(19) United States
(12) Patent Application Publication
(10) Pub. No.: US 2014/0142889 A1
(43) Pub. Date: May 22, 2014

(54) Throat Area Calculation for a Section of a Gas Turbine Engine

(71) Applicant: United Technologies Corporation, (US)

(72) Inventor: Conway Chuong, Manchester, CT (US)

(73) Assignee: United Technologies Corporation, Hartford, CT (US)

(21) Appl. No.: 13/630,145

(22) Filed: Sep. 28, 2012

(51) Int. Cl. G01B 21/28; G01M 15/14

(52) U.S. Cl. CPC G01B 21/28; G01M 15/14
USPC 702/156

(57) ABSTRACT

A method of calculating a throat area of a section of a machinery, according to an exemplary aspect of the present disclosure includes, among other things, outlining a boundary of the throat area of the section, selecting a plurality of inspection points along the boundary of the throat area, dividing the throat area into a plurality of sections, calculating an individual area of each of the plurality of sections and summing the individual areas of each of the plurality of sections to calculate the throat area.

### BACKGROUND

This disclosure relates to a gas turbine engine, and more particularly to a method of calculating a throat area of a section of a gas turbine engine.

Gas turbine engines typically include a compressor section, a combustor section and a turbine section. In general, during operation, air is pressurized in the compressor section and is mixed with fuel and burned in the combustor section to generate hot combustion gases. The hot combustion gases flow through the turbine section, which extracts energy from the hot combustion gases to power the compressor section and other gas turbine engine loads.

The compressor and turbine sections of the gas turbine engine typically include alternating rows of rotating blades and stationary vanes. The rotating blades either create or extract energy from the hot combustion gases that are communicated through the gas turbine engine, and the vanes convert the velocity of the airflow into pressure and prepare the airflow for the next set of blades.

The vanes are typically arranged in an array such that adjacent vanes of a vane assembly are circumferentially disposed about a longitudinal centerline axis of the gas turbine engine. The hot combustion gases that are communicated through the gas turbine engine flow through a throat area that extends between the adjacent vanes of the vane assembly. The throat area controls the pressure ratio and mass flow rate of the gas turbine engine.

The throat area associated with a particular section of a gas turbine engine, such as a turbine section, can be calculated using a series of gauges that measure the location of a pressure side and suction side of each airfoil of a vane assembly associated with the turbine section. These measurements can be used to mathematically calculate a throat area associated with the vane assembly. This method assumes axi-symmetric flow path surfaces and ignores any undulations or flow path end wall contouring of the platforms of the vane assembly, which potentially invalidate the calculation.

### SUMMARY

A method of calculating a throat area of a section of a machinery, according to an exemplary aspect of the present disclosure includes, among other things, outlining a boundary of the throat area of the section, selecting a plurality of inspection points along the boundary of the throat area, dividing the throat area into a plurality of sections, calculating an individual area of each of the plurality of sections and summing the individual areas of each of the plurality of sections to calculate the throat area.

In a further non-limiting embodiment of the foregoing method of calculating a throat area of a section of a machinery, the step of outlining includes outlining the boundary of the throat area using a CAD model of the section.

In a further non-limiting embodiment of either of the foregoing methods of calculating a throat area of a section of a machinery, the step of dividing includes radially dividing the throat area into the plurality of sections.

In a further non-limiting embodiment of any of the foregoing methods of calculating a throat area of a section of a machinery, the plurality of sections are trapezoidal shaped.

In a further non-limiting embodiment of any of the foregoing methods of calculating a throat area of a section of a machinery, the plurality of sections are triangular shaped.

In a further non-limiting embodiment of any of the foregoing methods of calculating a throat area of a section of a machinery, a first portion of the plurality of sections are trapezoidal shaped and a second portion of the plurality of sections are triangular shaped.

In a further non-limiting embodiment of any of the foregoing methods of calculating a throat area of a section of a machinery, the method includes calculating an error value is associated with the throat area.

In a further non-limiting embodiment of any of the foregoing methods of calculating a throat area of a section of a machinery, the step of adjusting the throat area is based on the error value.

In a further non-limiting embodiment of any of the foregoing methods of calculating a throat area of a section of a machinery, the step of calculating includes measuring a distance between a first portion of the plurality of inspections points located on an outer diameter portion of the boundary and a second portion of the plurality of inspection points located on an inner diameter portion of the boundary.

In a further non-limiting embodiment of any of the foregoing methods of calculating a throat area of a section of a machinery, the step of measuring a location of each of the plurality of inspection points uses a coordinate measuring machine (CMM).

In a further non-limiting embodiment of any of the foregoing methods of calculating a throat area of a section of a machinery, the section is a mid-turbine frame of a gas turbine engine.

In a further non-limiting embodiment of any of the foregoing methods of calculating a throat area of a section of a machinery, the section is a turbine section of a gas turbine engine.

A method of calculating a throat area of a section of a gas turbine engine, according to another exemplary aspect of the present disclosure includes, among other things, radially dividing a throat area of the section into a plurality of sections, calculating an individual area associated with each of the plurality of sections of the throat area and summing the individual areas of each of the plurality of sections to calculate the throat area.

In a further non-limiting embodiment of the foregoing method of calculating a throat area of a section of a gas turbine engine, the section is a turbine section of the gas turbine engine.

In a further non-limiting embodiment of either the foregoing methods of calculating a throat area of a section of a gas turbine engine, the method includes outlining a boundary of the throat area of the turbine section in a CAD model prior to the step of radially dividing.

In a further non-limiting embodiment of any of the foregoing methods of calculating a throat area of a section of a gas turbine engine, the method includes selecting a plurality of inspection points along the boundary of the throat area.

In a further non-limiting embodiment of any of the foregoing methods of calculating a throat area of a section of a gas turbine engine, the boundary includes an outer diameter portion, an inner diameter portion, a suction side portion and a pressure side portion and the plurality of inspection points are selected on each of the outer diameter portion, the inner diameter portion, the suction side portion and the pressure side portion.

In a further non-limiting embodiment of any of the foregoing methods of calculating a throat area of a section of a gas turbine engine, the step of radially dividing includes measuring a radial distance between a plurality of outer diameter portions and a plurality of inner diameter portions of a boundary of the throat area.

In a further non-limiting embodiment of any of the foregoing methods of calculating a throat area of a section of a gas turbine engine, the section includes an end wall having at least one undulation.

In a further non-limiting embodiment of any of the foregoing methods of calculating a throat area of a section of a gas turbine engine, the method includes adjusting the throat area calculation based on an error value associated with a trailing edge location of the section.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIGS. 2A and 2B illustrate a segment of a section of a gas turbine engine.

FIG. 3 schematically illustrates a throat area associated with a segment of a section of a gas turbine engine.

FIG. 4 schematically illustrates a method of calculating a throat area of a segment of a section of a gas turbine engine.

### DETAILED DESCRIPTION

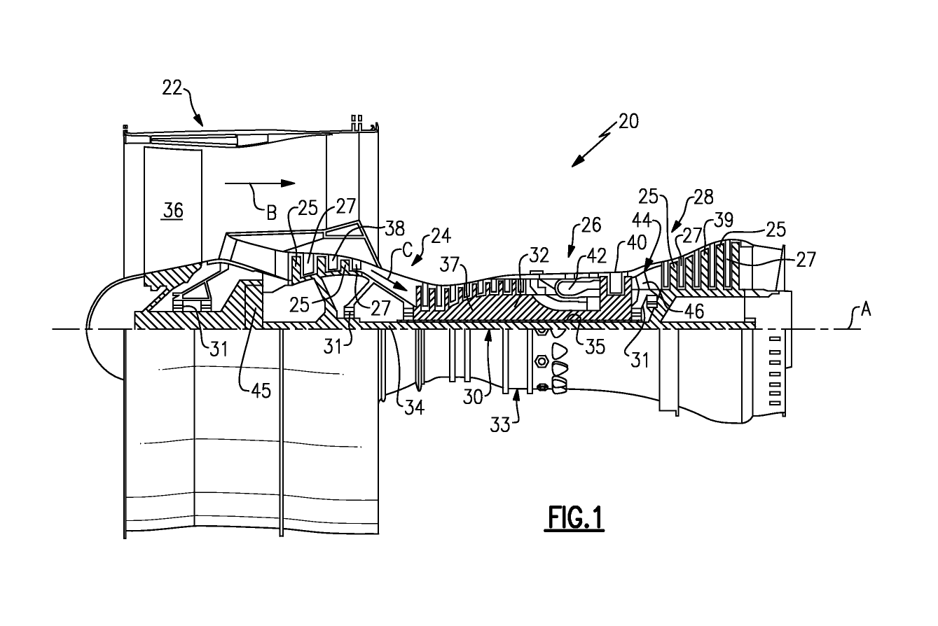

FIG. 1 schematically illustrates a gas turbine engine 20. The exemplary gas turbine engine 20 is a two-spool turbofan engine that generally incorporates a fan section 22, a compressor section 24, a combustor section 26 and a turbine section 28. Alternative engines might include an augmentor section (not shown) among other systems for features. The fan section 22 drives air along a bypass flow path B, while the compressor section 24 drives air along a core flow path C for compression and communication into the combustor section 26. The hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

In a non-limiting embodiment, the gas turbine engine 20 is a high-bypass geared aircraft engine. In a further example, the gas turbine engine 20 bypass ratio is greater than about six (6:1). The geared architecture 45 can include an epicyclic gear train, such as a planetary gear system or other gear system. The example epicyclic gear train has a gear reduction ratio of greater than about 2.3, and in another example is greater than about 2.5:1. The geared turbofan enables operation of the low speed spool 30 at higher speeds, which can increase the operational efficiency of the low pressure compressor 38 and low pressure turbine 39 and render increased pressure in a fewer number of stages.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only exemplary of one embodiment of a geared architecture engine and that the present disclosure is applicable to other gas turbine engines, including direct drive turbofans.

In this embodiment of the exemplary gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [(Tram °R)/(518.7 °R)]^{0.5}, where T represents the ambient temperature in degrees Rankine. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 of the rotor assemblies create or extract energy (in the form of pressure) from the core airflow that is communicated through the gas turbine engine 20 along the core flow path C. The vanes 27 of the vane assemblies direct the core airflow to the blades 25 to either add or extract energy.

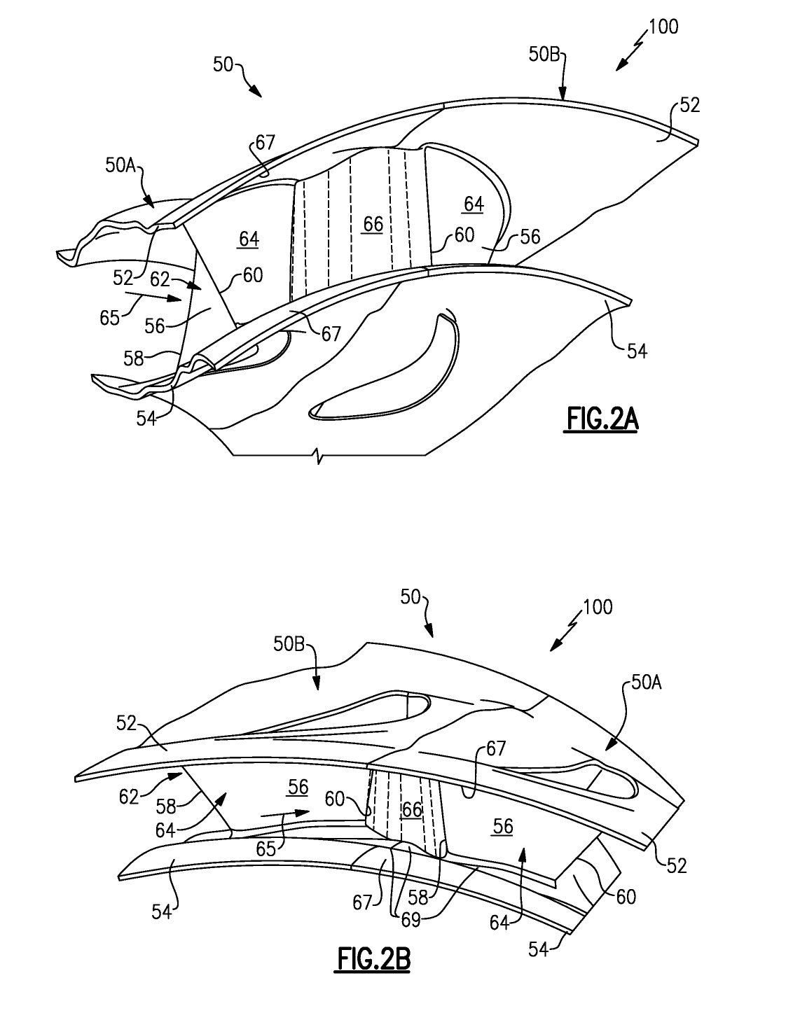

FIGS. 2A and 2B illustrate a vane segment 50 that can be incorporated into a section 100 of a gas turbine engine, such as the gas turbine engine 20 of FIG. 1. In this embodiment, the section 100 is the turbine section 28 of the gas turbine engine 20 and the vane segment 50 is part of a vane assembly disposed within the turbine section 28. However, other sections of a gas turbine engine 20 could also benefit from the teachings of this disclosure, including but not limited to, the compressor section and the mid-turbine frame.

The vane segment 50 can include a single annular structure or a plurality of vane segments 50 could be mechanically attached to one another and annularly disposed about the engine centerline axis A to form a full-ring vane assembly. The vane segment 50 could include one or more airfoils (or vanes) 56. In this particular embodiment, the section 100 includes a first vane segment 50A and a second vane segment 50B each having a single airfoil 56.

The first and second vane segments 50A, 50B include an outer diameter platform 52 and an inner diameter platform 54 spaced from the outer diameter platform 52. The airfoils 56 extend between the outer diameter platform 52 and the inner diameter platform 54. The airfoils 56 may extend radially across an annulus between the outer diameter platform 52 and the inner diameter platform 54. Each airfoil 56 includes a leading edge 58, a trailing edge 60, a pressure side 62 and a suction side 64. The airfoils 56 axially extend between the leading edge 58 and the trailing edge 60 and circumferentially extend between the pressure side 62 and the suction side 64.

A gas path 65 is communicated axially downstream through the gas turbine engine 20 along the core flow path C (FIG. 1) in a direction that extends from the leading edges 58 toward the trailing edges 60 of the airfoils 56. The gas path 65 represents the communication of core airflow across the airfoils 56 and through the spaces that extend between the adjacent airfoils 56 of the first and second vane segments 50A, 50B. The space that extends between adjacent airfoils 56 of the vane segments 50A, 50B is referred to as a throat area 66.

As best illustrated in FIG. 2B, the inner diameter platform 54 and the outer diameter platform 52 of one or both of the first and second vane segments 50A, 50B include end walls 67 that establish the radially outer and radially inner flow path boundaries of the gas path 65. One or more of the end walls 67 can include undulations 69 that provide a contoured end wall surface. The undulations 69 may reduce friction losses that can occur as the airflow of the gas path 65 is communication through the section 100, thereby increasing engine efficiency. However, these undulations 69 can also add difficulty in calculating the throat area 66 using known throat area calculation methodologies.

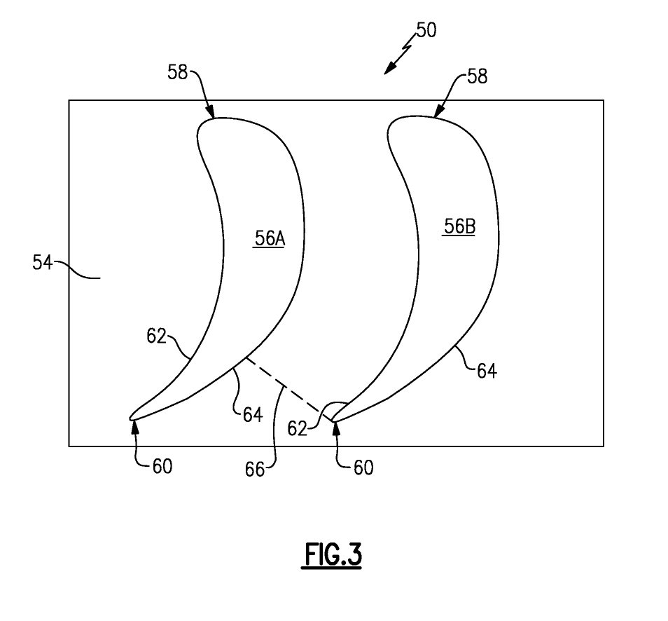

FIG. 3 schematically illustrates a throat area 66 of a vane segment 50. The throat area 66 extends between a first airfoil 56A and a second, adjacent airfoil 56B of the vane segment 50. The throat area 66 of the vane segment 50 is a planar opening with a periphery bounded in a radial direction by the outer diameter platform 52 (shown in FIG. 2) and the inner diameter platform 54 and peripherally bounded in the circumferential direction by the suction side 64 of the first airfoil 56A and the trailing edge 60 of the second airfoil 56B (at the pressure side 62). Of course, a full ring vane assembly would include a plurality of throat areas that extend between adjacent airfoils. The throat area 66 of the vane segment 50 is an important parameter that may influence engine efficiency. Therefore, the throat area 66 must be periodically measured and calculated to verify clearances in the core flow path C.

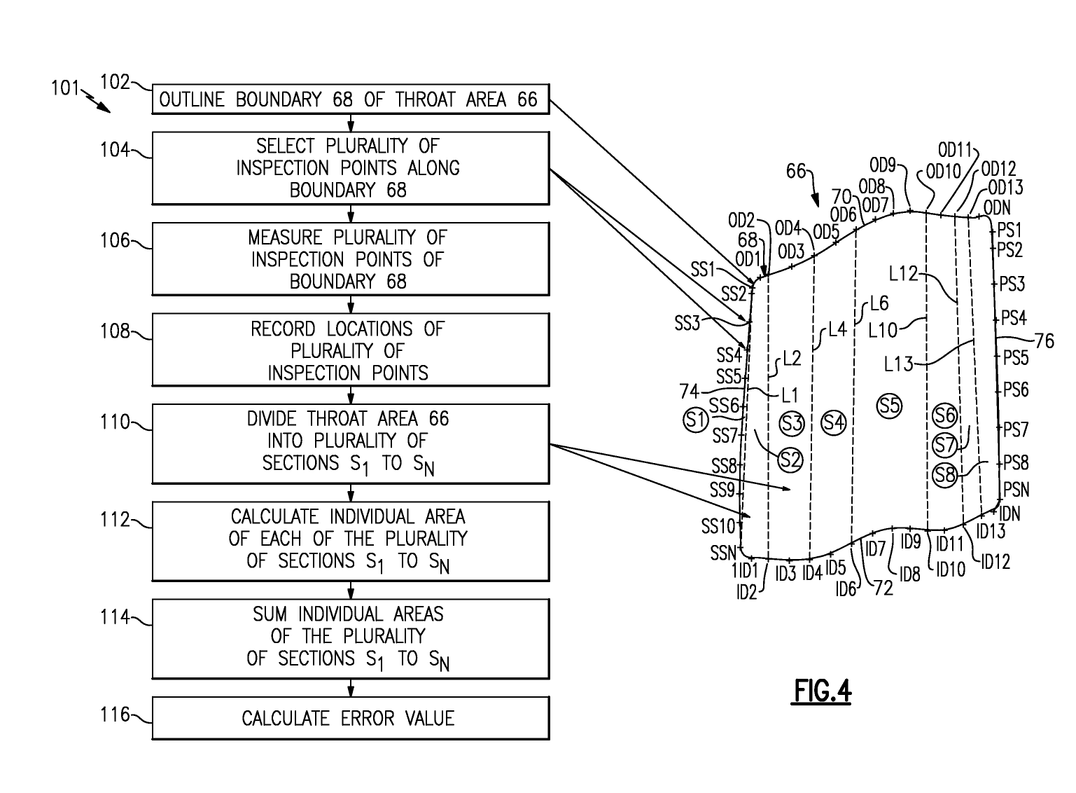

FIG. 4, with continued reference to the previous Figures, schematically illustrates an exemplary method 101 of calculating a throat area 66 of a section of a gas turbine engine. In one embodiment, the method 101 can be used to calculate a throat area 66 associated with a turbine vane assembly of the gas turbine engine, although other sections could also benefit from the teachings of this disclosure. The method 101 may be particularly useful for calculating a throat area on segments of the gas turbine engine that include flow path end wall contouring (see, e.g., undulations 69 of end walls 67 illustrated by FIG. 2B).

The method may begin at step block 102 by outlining a boundary 68 of the throat area 66. In one embodiment, the boundary 68 is outlined using a CAD model of a section of the gas turbine engine. A person of ordinary skill in the art having the benefit of this disclosure would be able to select and outline the boundary 68 of the throat area 66 by referencing a CAD model.

The boundary 68 is an outer periphery of the throat area 66. In this embodiment, the boundary 68 extends radially between an outer diameter portion 70 and an inner diameter portion 72 and extends circumferentially between a suction side portion 74 and a pressure side portion 76. The outer diameter portion 70 and the inner diameter portion 72 represent the locations where the throat area 66 is bounded by the outer diameter platform 52 and the inner diameter platform 54, respectively (see FIGS. 2A, 2B). The outer diameter portion 70 and the inner diameter portion 72 may be contoured to reflect any undulations 69 formed in the end walls 67 of the outer diameter platform 52 and/or the inner diameter platform 54. In other words, the outer diameter portion 70 and the inner diameter portion 72 may extend non-linearly as shown. In addition, the suction side portion 74 of the boundary 68 represents the portion of the throat area 66 that extends adjacent a suction side 64 of a first airfoil 56A of the section and the pressure side portion 76 represents the portion of the throat area 66 that extends adjacent the pressure side 62 of a second, adjacent airfoil 56B of the section (see, for example, the vane segment 50 of FIG. 3). The suction side portion 74 and the pressure side portion 76 are linear in this embodiment.

Next, at step block 104, a plurality of inspection points (marked in FIG. 4 with a +sign) are selected along the boundary 68 of the throat area 66. For example, a plurality of inspection points OD₁ through OD_{N} are selected along the outer diameter portion 70, a plurality of inspection points ID₁ through ID_{N} are selected along the inner diameter portion 72, a plurality of inspection points SS₁ through SS_{N} are selected along the suction side portion 74 and a plurality of inspection points PS₁ through PS_{N} are selected along the pressure side portion 76. In one embodiment, the locations of these various inspection points may be specified in an engineering print or CAD model of the section of the gas turbine engine. However, the plurality of inspection points may also be selected using other known methodologies.

The plurality of inspection points of the boundary 68 of the throat area 66 can be measured at step block 106. For example, each of the plurality of inspection points can be measured on an actual casting of the section of the gas turbine engine using a coordinate measuring machine (CMM). Other measuring techniques are also contemplated as within the scope of this disclosure. The actual locations of the plurality of inspection points of the boundary 68 can be recorded at step block 108, including, to the extent the location is incorrect, a recordation of an out-of-nominal distance associated with each of the plurality of inspection points. As discussed below, the CMM data is later used to calculate the area of a plurality of sections of the throat area 66.

At step block 110, the throat area 66 is divided into a plurality of sections S₁ through S_{N}. In one embodiment, the throat area 66 is radially divided into the plurality of sections S_{N} by drawing radial lines L₁ through L_{N} from at least a first portion of the plurality of inspection points OD₁ through OD_{N} to a corresponding second portion of the plurality of inspection points ID₁ through OD_{N}. In this embodiment, the inspection points OD₂ and ID₂ are connected by radial line L₂ that defines a radial distance, inspection points OD₄ and ID₄ are connected by radial line L₄ that defines a radial distance, inspection points OD₆ and ID₆ are connected by radial line L₆ that defines a radial distance, inspection points OD₁₀ and ID₁₀ are connected by radial line L₁₀ that defines a radial distance, inspection points OD₁₂ and ID₁₂ are connected by radial line L₁₂ that defines a radial distance, and inspection points OD₁₃ and M_{B} are connected by a radial line L₁₃ that defines a radial distance. This is but one example of how the throat area 66 could be divided, and it should be understood that the throat area 66 could be divided into greater or fewer sections than are illustrated in this embodiment. The division of the throat area 66 into the plurality of sections S₁ through S_{N} may also depend on the design of the section for which the throat area is being calculated. That is, the throat areas 66 of different parts may be divided into different numbered and shaped sections.

The plurality of sections S₁ through S_{N} that divide the throat area 66 may embody a variety of shapes. For example, the plurality of sections S₁ through S_{N} can be trapezoidal shaped. In another embodiment, the plurality of sections S₁ through S_{N} can be triangular shaped. In yet another embodiment, a first portion of the plurality of sections S₁ through S_{N} are trapezoidal shaped and a second portion of the plurality of sections S₁ through S_{N} are triangular shaped sections. Other shapes are also contemplated. For example, each shape may be one in which an area of the shape can be easily mathematically calculated.

Next, at step block 112, an individual area of each of the plurality of sections S₁ through S_{N} is calculated. A person of ordinary skill in the art having the benefit of this disclosure would understand how to calculate the area of each of the plurality of sections S₁ through S_{N}. For example, as is known, the area of a triangle can be calculated using the formula A=½(b)(h), where b is the length of the base of the triangle and h is the height of the triangle. In another example, the area of a trapezoid can be calculated using the formula ½(b₁+b₂)h, where b₁ and b₂ are the lengths of the bases and h is the height. In this embodiment, the lengths of the radial lines L₁ through L_{N} can be used as the “h” values in the area formulas. These radial distances are measured and calculated from the CMM inspection data from step block 108. At step block 114, the individual areas of each of the plurality of sections S₁ through S_{N} can be summed to calculate the throat area 66.

An error value associated with the throat area 66 calculation can optionally be calculated at step block 116. It may be necessary to calculate the error value associated with the throat area 66 calculation because the airfoil 56 of a section can be cast with a trailing edge 60 that is shorter or longer (due to shrinkage error) than defined by the engineering print or CAD model of the section. The calculated throat area 66 can be adjusted based on the error value calculated at step block 116. The error value may also be added to account for slight inabilities of the formula to measure the exact flow area value that can result from a coarse number of divisions of the flow area surface. Additional methods may be incorporated to account for throat area 66 value effects from the trailing edge 60 location.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

We claim:

1. A method of calculating a throat area of a section of a machinery, comprising the steps of:
outlining a boundary of the throat area of the section;
selecting a plurality of inspection points along the boundary of the throat area;
dividing the throat area into a plurality of sections;
calculating an individual area of each of the plurality of sections; and
summing the individual areas of each of the plurality of sections to calculate the throat area.

2. The method as recited in claim 1, wherein the step of outlining includes outlining the boundary of the throat area using a CAD model of the section.

3. The method as recited in claim 1, wherein the step of dividing includes radially dividing the throat area into the plurality of sections.

4. The method as recited in claim 1, wherein the plurality of sections are trapezoidal shaped.

5. The method as recited in claim 1, wherein the plurality of sections are triangular shaped.

6. The method as recited in claim 1, wherein a first portion of the plurality of sections are trapezoidal shaped and a second portion of the plurality of sections are triangular shaped.

7. The method as recited in claim 1, comprising the step of calculating an error value associated with the throat area.

8. The method as recited in claim 7, comprising the step of adjusting the throat area based on the error value.

9. The method as recited in claim 1, wherein the step of calculating includes measuring a distance between a first portion of the plurality of inspections points located on an outer diameter portion of the boundary and a second portion of the plurality of inspection points located on an inner diameter portion of the boundary.

10. The method as recited in claim 1, comprising the step of measuring a location of each of the plurality of inspection points using a coordinate measuring machine (CMM).

11. The method as recited in claim 1, wherein the section is a mid-turbine frame of a gas turbine engine.

12. The method as recited in claim 1, wherein the section is a turbine section of a gas turbine engine.

13. A method of calculating a throat area of a section of a gas turbine engine, comprising the steps of:
radially dividing a throat area of the section into a plurality of sections;
calculating an individual area associated with each of the plurality of sections of the throat area; and
summing the individual areas of each of the plurality of sections to calculate the throat area.

14. The method as recited in claim 13, wherein the section is a turbine section of the gas turbine engine.

15. The method as recited in claim 13, comprising the step of outlining a boundary of the throat area of the turbine section in a CAD model prior to the step of radially dividing.

16. The method as recited in claim 15, comprising the step of selecting a plurality of inspection points along the boundary of the throat area.

17. The method as recited in claim 16, wherein the boundary includes an outer diameter portion, an inner diameter portion, a suction side portion and a pressure side portion and the plurality of inspection points are selected on each of the outer diameter portion, the inner diameter portion, the suction side portion and the pressure side portion.

18. The method as recited in claim 13, wherein the step of radially dividing includes measuring a radial distance between a plurality of outer diameter portions and a plurality of inner diameter portions of a boundary of the throat area.

19. The method as recited in claim 13, wherein the section includes an end wall having at least one undulation.

20. The method as recited in claim 13, comprising the step of adjusting the throat area calculation based on an error value associated with a trailing edge location of the section.
